(19) United States
(12) Patent Application Publication
(10) Pub. No.: US 2024/0399345 A1
(43) Pub. Date: Dec. 5, 2024

(54) APPARATUS FOR REDUCING NOx AND METHOD FOR PREPARING A CATALYST FOR REDUCING NOx

(71) Applicant: FINDEN LTD, Abingdon (GB)

(72) Inventors: Andrew BEALE, Abingdon (GB); Wilm JONES, Abingdon (GB); Simon JACQUES, Abingdon (GB)

(21) Appl. No.: 18/686,352

(22) PCT Filed: Aug. 26, 2022
(86) PCT No.: PCT/GB2022/052194

§ 371 Date: Feb. 23, 2024

(30) Foreign Application Priority Data
Aug. 27, 2021 (GB) 2112310.4

(51) Int. Cl. B01J 23/89; B01D 53/86; B01J 27/24

(52) U.S. Cl. CPC B01J 23/8926; B01D 53/8628; B01D 53/8631; B01J 27/24; B01D 2255/1021; B01D 2255/20761; B01D 2257/404; B01D 2259/4508

(57) ABSTRACT

The present invention relates to an apparatus for reducing NOx in air, and a method of preparing a catalyst for reducing NOx in air, wherein the catalyst is for use in the apparatus. The apparatus comprises a catalyst, wherein the catalyst comprises Pt, PtCu, PtCo, PtNi, Pd, PtPd and/or PdCu. The apparatus further comprises a reaction chamber for receiving the catalyst, comprising an inlet for air and reductant, and an outlet. A heater is configured to heat the catalyst to temperatures of from 20° C. to 100° C. The apparatus also comprises a source of reductant, wherein the source of reductant is connected to the inlet. The method comprises step a) of combining a support material in water with a stabilising polymer to form an aqueous solution. Step b) includes adding a first metallic compound to the aqueous solution formed in step a), and stirring the solution. Step c) includes adding a reducing agent to the solution formed in step b), so as to form metallic nanoparticles. Step d) includes adding an acid to the solution formed in step c). Step e) includes stirring the solution formed in step d) and subsequently filtering and drying to form supported metallic nanoparticles.

### FIELD OF DISCLOSURE

The present invention relates to an apparatus for reducing nitrogen oxides (NOx) in air; a method of reducing NOx inside an enclosed space using the apparatus; and a method of preparing a catalyst for reducing NOx.

### BACKGROUND

Nitrogen oxides are a group of gases, referred to collectively hereinafter as ‘NOx’, which include nitrogen monoxide (NO) and nitrogen dioxide (NO₂). NO constitutes the major portion of NOx gas and can combine with oxygen to form NO₂. NOx is emitted into the atmosphere in various different ways. A major contributor to NOx emissions is the combustion of fuels at high temperature, i.e. over 1200° C., for example, by road transport; by energy industries, including power plants; by manufacturing industries, including industrial boilers; and by non-road transport (including aviation, rail and shipping). It was estimated in 2019 that up to 80% of the NO₂ concentration in the UK originates as NOx emissions from road transport (https://www.gov.uk/govemment/statistics/emissions-of-air-pollutants/emissions-of-air-pollutants-in-the-uk-nitrogen-oxides-nox). Upon combustion of fuels, NOx is formed due to reaction of nitrogen (either in the air or in the fuel) with atmospheric oxygen. NOx is also produced naturally by lightning and by microbial processes in soils.

NOx is an environmental pollutant which reacts to form acid rain and smog. NOx can adversely affect biodiversity and habitats due to causing changes in soil chemistry. NOx can also form ozone by reaction with volatile organic compounds. Ozone can cause environmental problems by oxidising vegetation and crops. Furthermore, ozone can cause and exacerbate respiratory tract problems, such as an asthma attack, and trigger irritation in the eyes, nose and throat. NO₂ specifically is also harmful to health and can cause inflammation and infections of the respiratory system. NO₂ can also exacerbate pre-existing conditions, such as asthma, and other lung and heart conditions.

Attempts to reduce NOx emissions resulting from human activity have been made. Selective catalytic reduction (SCR) systems convert the NOx in exhaust or flue gas streams into nitrogen gas and water by reacting the NOx with a reductant. SCR systems are widely used commercially, for example, in power plants, boilers, gas turbines and in diesel engines in ships and road vehicles. Known SCR catalysts include an active catalytic component, which is typically based on a zeolite, precious metals or oxides of metals such as vanadium, tungsten and molybdenum. Precious metal SCR research relating to reduction of NOx emissions has been reported in the literature, for example, in Surface Science [online: http://dx.doi.org/10.1016/j.susc.2009.05.031] Vol. 603, 12 Jun. 2009, K Okumura et al, “Effect of combination of noble metals and metal oxide supports on catalytic reduction of NO by H₂”, pages 2544 to 2550; and in Angewandte Chemie International Edition [online: https://doi.org/10.1002/anie.200500919]Vol. 44, 8 Jul. 2005, S Zhou et al, “Pt—Cu Core-Shell and Alloy Nanoparticles for Heterogeneous NOx Reduction: Anomalous Stability and Reactivity of a Core-Shell Nanostructure.”

Commonly used reductants are liquid or aqueous ammonia. Despite relatively high NOx conversion efficiencies, a problem with known SCR systems is that the effective temperature range required is typically from 177° C. to 593° C. (Environmental Progress Vol 13 (4), November 1994, R M Heck et al, “Operating characteristics and commercial operating experience with high temperature SCR NOx catalyst”, pages 221 to 225). The specific temperature required depends on various factors, including the catalyst material and geometry. Thus, there are limited environments in which known SCR systems can be used. Reduction of NOx concentration may also proceed via an oxidative pathway. NOx mitigating catalysts that proceed via an oxidative pathway are susceptible to nitrates, such as nitric acid, poisoning the surface of the catalyst and thus deactivation.

An alternative method for reducing NOx emissions is selective non-catalytic reduction (SNCR), which involves reacting NOx with a reductant to form nitrogen and water. Reductants such as urea or ammonia may be used. Due to the absence of a catalyst, temperatures in the range of 850° C. to 1100° C. are required, depending on the reductant used. Such temperatures are higher than those required for SCR and a lower NOx conversion efficiency is achieved in comparison to SCR. Therefore, SNCR systems are only suitable for relatively small installations in environments where NOx emissions are low.

Further methods of reducing NOx emissions include use of a NOx adsorber, which includes a catalyst support coated with a material which reversibly adsorbs (conventionally known as lean NOx traps (LNTs), i.e. binds to or ‘traps’ NOx particles. Typical adsorbers are zeolites or carbonates. Once the adsorber is saturated with NOx, it is regenerated, for example, by injecting diesel fuel to cause the NOx to desorb from the zeolite and react with hydrocarbons contained in the diesel fuel to produce nitrogen gas and water. NOx adsorbers have a higher affinity for sulfur oxides than for NOx, so a problem is that periodic, high temperature desulfation is required in order to remove the sulfur oxides and restore the activity of the adsorber. Absorption techniques are also used to remove NOx. For example, sulfuric acid reacts with NOx at high pressure and relatively low temperature (35° C.). However, NOx conversion efficiencies are low, the use of corrosive chemicals is required and relatively large areas are required to house the necessary equipment.

NOx absorbers are known for reducing NOx indoors. NOx absorbers are a component part of Mechanically Ventilated Heat Recovery (MVHR) systems. Such systems may include disposable, high-efficiency particulate absorbing (HEPA) filters and carbon filters for absorbing NOx. Such systems are used domestically and commercially. Although HEPA and carbon filters can reduce NOx by 90%, they usually require replacement every 12 months (https://www.dyson.com/air-treatment/purifier-accessories).

Known methods for producing supported metallic, nanoparticle catalysts for NOx concentration reduction suffer from the problem of large particle size distribution. Known methods are shown to cause a high degree of alloying between the metallic components of the catalyst, which in some situations can adversely affect the catalytic activity of the supported metallic nanoparticle

It is an object of the invention to at least alleviate the above-mentioned disadvantages.

### Means for Solving the Problem

According to a first aspect of the present invention, there is provided an apparatus for reducing NOx in air, wherein the apparatus comprises a catalyst. The catalyst comprises Pt, PtCu, PtCo, PtNi, Pd, PtPd and/or PdCu. The apparatus further comprises a reaction chamber for receiving the catalyst. The reaction chamber comprises an inlet for air and reductant and an outlet. The reaction chamber further comprises a heater configured to heat the catalyst to temperatures of from 20° C. to 100° C.; and a source of reductant, wherein the source of reductant is connected to the inlet.

Advantageously, the apparatus facilitates reduction of concentration of NOx in air at lower temperatures than conventional catalytic systems for reduction of NOx concentration, via a reductive catalytic pathway. Thus, the apparatus is more energy efficient than conventional systems. Due to the use of relatively low temperatures, the apparatus is also safer than conventional systems. This means that the apparatus can be installed in a wider variety of locations, such as inside buildings, without requiring evacuation of people from inside of the building. In addition, the use of relatively low temperatures prevents production of ammonia as a by-product of the reduction reaction. Advantageously, the by-products of the reduction of NOx are nitrogen, and/or N₂O, which are both inert gases at temperatures from 20° C. to 100° C. The apparatus of the present invention also does not suffer from a build up of nitrates or nitric acid on the surface of the catalyst.

Preferably, the reductant is hydrogen. Hydrogen is cheap and readily available, and assists the catalyst with reducing NOx at relatively low temperatures in comparison to conventional systems. Hydrogen also does not pose an environmental risk.

Preferably, the apparatus further comprises a source of a substance for providing the reductant (i.e an indirect source of the reductant). The reductant, such as hydrogen, may be generated by reforming another substance or chemical. T substance may be a pollutant, wherein a pollutant is a substance which causes undesirable effects on the environment. Formaldehyde is an example of a substance which is a pollutant, which can advantageously provide hydrogen as a reductant. During use of the apparatus, formaldehyde would only be present at background levels, meaning that any adverse environmental risk would be minimal.

Preferably, the heater is configured to heat the catalyst to temperatures of from 20° C. to 25° C. The apparatus has been observed to reduce NOx particularly efficiently and safely in this temperature range.

Preferably, the source of reductant comprises an electrolyser for producing the reductant. An electrolyser allows the reductant, such as hydrogen, to be quickly and easily produced by, for example, splitting water, on demand and in situ. This prevents the reductant, for example, hydrogen, from being wasted.

Preferably, the reductant is hydrogen, and hydrogen is present in a concentration of 0.05 v/v % to 4 v/v %. Advantageously, good conversion of NOx to nitrogen and/or N₂O is observed within this concentration range, without posing a flammability risk.

Preferably, hydrogen is present in a concentration of 0.05 v/v % to 1 v/v %. This range of concentrations of hydrogen is particularly effective when the catalyst is 0.1 wt % Pt—TiO₂.

Preferably, the apparatus comprises a flow rate controller for increasing or decreasing the flow rate of the reductant. Depending on the composition of the catalyst, the flow rate of hydrogen can be tuned so that optimal reduction of NOx is achieved.

Preferably, the flow rate controller is configured to increase the flow rate of the reductant for 5 to 15 seconds. Thus, the flow rate controller is configured to increase the flow rate of the reductant from a first flow rate, to an increased, second flow rate. The increased, second flow rate of reductant is maintained for a period of 5 to 15 seconds. Once this period has elapsed, the flow rate controller is configured to decrease the flow rate of the reductant from the increased, second flow rate, back down to the first flow rate. Temporarily increasing the flow rate of the reductant, such as hydrogen, creates a pulsing effect. By pulsing the reductant in the presence of the catalyst, the catalytic activity of catalyst is effectively regenerated. Thus, advantageously, the catalyst requires replacement less frequently, which provides a cost saving. In addition, regeneration of the catalyst can be performed in situ, making maintenance of the apparatus quicker and easier.

Preferably, the catalyst is supported on a support. Advantageously, the support maximises the specific surface area of the catalyst, in order to improve the activity of the catalyst. A typical support comprises graphitic carbon nitride (gC₃N₄), silica, titanium dioxide, activated carbon and/or alumina.

Preferably, the catalyst is present in an amount of from 0.1 wt % to 10 wt % with respect to the combined weight of the catalyst and the support. Particularly efficient reduction of NOx concentration is observed when the catalyst is used in this concentration range. Preferably, the catalyst is PtCu, the support is gC₃N₄, and PtCu is present in an amount of 0.1 wt % to 10 wt % with respect to the combined weight of PtCu and gC₃N₄.

Preferably, the apparatus comprises at least one gas detector in communication with the outlet, wherein the at least one gas detector is configured to detect nitrogen monoxide (NO), and/or nitrous oxide (N₂O) in the gas which exits the reaction chamber. Advantageously, detection of NO and N₂O allows the operator to monitor the performance of the apparatus and can indicate whether the apparatus requires maintenance. By monitoring the NO and N₂O concentrations, the concentration of nitrogen can be deduced therefrom. A NOx detector can therefore provide the user with information on the NOx concentration levels. In response to this information, the flow rate controller may be adjusted to optimise the flow of reductant (e.g. hydrogen) into the apparatus.

Preferably, at least one gas detector comprises a chemiluminescence detector for detecting nitric oxide (NO) and/or nitrogen dioxide (NO₂). Advantageously, a chemiluminescence detector has a wide NO detection range of 0.5 ppb to 20 ppm and is thus more sensitive to NO than conventional NO detectors. An alternative detector is an electrochemical detector, which advantageously is of a small size and of low cost.

Preferably, at least one gas detector comprises an infrared detector for detecting nitrous oxide (N₂O). Although N₂O is inert in the temperature range operated in by the apparatus, depending on the environment in which the apparatus is located, it may be desired to monitor the N₂O levels.

According to a second aspect of the present invention, there is provided a system for monitoring the concentration of NOx in air in a plurality of enclosed spaces comprising a plurality of the apparatus' according to the first aspect of the present invention. Each of the plurality of apparatus' comprises at least one gas detector in communication with the outlet, wherein the at least one gas detector is configured to detect nitrogen monoxide (NO) in the gas which exits the reaction chamber; and wherein each of the plurality of the apparatus' are positioned in each of the plurality of enclosed spaces. Such a system allows for comparisons of NOx concentrations to be made between different areas within enclosed spaces. This assists the operator with determining whether the apparatus' are functioning correctly, and/or whether operation parameters, such as temperature and/or catalyst concentration require adjustment.

According to a third aspect of the present invention, there is provided a method of reducing NOx inside an enclosed space, comprising the steps of providing an apparatus for reducing NOx according to the first aspect of the present invention; pumping air from inside the enclosed space into the reaction chamber via the inlet; introducing reductant into the reaction chamber, such that the reductant, air and catalyst are exposed to each other; heating the reaction chamber to a temperature in a range of 20° C. to 100° C.; and pumping gas from the reaction chamber, through the outlet, into the enclosed space.

According to a fourth aspect of the present invention, there is provided a method of preparing a catalyst for reducing NOx in air comprising: a) combining a support material in water with a stabilising polymer to form an aqueous solution; b) adding a first metallic compound to the aqueous solution formed in step a), and stirring the solution; c) adding a reducing agent to the solution formed in step b), so as to form metallic nanoparticles; d) adding an acid to the solution formed in step c); e) stirring the solution formed in step d) and subsequently filtering and drying to form supported metallic nanoparticles. Advantageously, this method provides an easy way of preparing a catalyst having a narrow particle size distribution. Catalysts prepared via this method have been observed to efficiently reduce the concentration of NOx in the apparatus according to the first aspect of the present invention in a low temperature range, particularly when hydrogen is used as a reductant.

Preferably, the first metallic compound comprises platinum or palladium. Advantageously, platinum and palladium catalysts have been shown to provide effective catalysts for NOx reduction at relatively low temperatures.

Preferably, the method further comprises adding a second metallic compound to the aqueous solution formed in step a), wherein the first metallic compound is different to the second metallic compound. Advantageously, the method can be used to prepare bimetallic nanoparticles, which are particularly effective as NOx reducing catalysts in the apparatus according to the first aspect of the present invention.

Preferably, the first metallic compound comprises platinum and the second metallic compound comprises one of copper, cobalt or nickel. Advantageously, such combinations of metallic elements provide bimetallic NOx reducing catalysts which effectively convert NOx to inert products.

Preferably, the first metallic compound comprises palladium and the second metallic compound comprises copper. A catalyst including palladium and copper can be easily prepared using the above method.

Preferably, the second metallic compound is a nitrate of copper, nickel or cobalt. Such materials are readily available, easy to handle and are particularly suited for use in a method according to the fourth aspect of the present invention.

According to a fifth aspect of the present invention, there is provided a catalyst for reducing NOx in air prepared by the method according to the fourth aspect of the present invention, wherein the catalyst is for use in an apparatus according to the first aspect of the present invention.

Where numerical ranges are described within this specification, such ranges are to be interpreted as including and disclosing both of the end points of the range.

### BRIEF DESCRIPTION OF THE DRAWINGS

Various embodiments and aspects of the present invention are described without limitation below, with reference to the accompanying figures.

FIG. 1 shows a schematic representation of an apparatus for reducing NOx in air.

FIG. 2 shows a flow chart for a method of reducing NOx inside an enclosed space, using the apparatus as shown in FIG. 1.

FIG. 3 shows an activity plot for a 1 wt % PtCu-gC₃N₄ catalyst used in the apparatus of FIG. 1.

FIG. 4 shows an activity plot for a 0.1 wt % Pd—TiO₂ catalyst used in the apparatus of FIG. 1.

FIG. 5 shows an activity plot for a 0.1 wt % Pd—TiO₂ catalyst used in the apparatus of FIG. 1.

FIG. 6 shows ATR (attenuated total reflectance) spectra for a 0.1 wt % Pd—TiO₂ catalyst before and after use in the apparatus of FIG. 1.

FIG. 7 shows an activity plot for a 0.1 wt % Pt—TiO₂ catalyst used in the apparatus of FIG. 1.

FIG. 8 shows an activity plot for a 0.05 wt % Pt 0.05 wt % Pd—TiO₂ catalyst used in the apparatus of FIG. 1.

FIGS. 9a and 9b show activity plots for a 1 wt % PtCu-gC₃N₄ catalyst synthesised via a method outside of the scope of the present invention, used in the apparatus of FIG. 1.

FIGS. 9c and 9d show activity plots for a 1 wt % PtCu-gC₃N₄ catalyst synthesised via a method according to the present invention, used in the apparatus of FIG. 1.

FIG. 10 shows a flow chart for preparing the catalyst via a method according to the present invention.

### DETAILED DESCRIPTION OF A PREFERRED EMBODIMENT

The present invention relates generally to reducing NOx in air. More particularly, aspects of the present invention relate to a reaction chamber and an apparatus including that reaction chamber, wherein the reaction chamber has an interior for housing a catalyst therein and reduces the amount of NOx from air taken from outside the reaction chamber. Other aspects include a method of preparing a catalyst for reducing NOx in air.

The apparatus of the present invention is for the reduction of NOx concentration in air in a relatively low temperature range, in comparison with known systems. The apparatus is therefore safer and more energy efficient than known systems. The method of preparing a catalyst for reducing NOx in air provides metallic catalysts having a narrow particle size distribution, which are suitable for use in the apparatus of the present invention.

### NOx Reduction Apparatus

Described herein is an apparatus 1 for reducing NOx (including nitrogen monoxide (NO) and nitrogen dioxide (NO₂)) in air. In a preferred embodiment, the apparatus 1 may be deployed in an enclosed space. The enclosed space may be inside of a building, for example in a room, stairwell or corridor of a building. The term “building” covers outbuildings such as a garage or cabin. The phrase “enclosed space” covers, for example, an indoor environment such as a room, stairwell, corridor, garage, or cabin which has apertures which may be opened and closed. For example, the phrase “enclosed space” covers a room which has a doorway which is able to be opened or closed by a door; and/or windows, which may be opened or closed. An “enclosed space” includes, for example, a room where a window is open or closed.

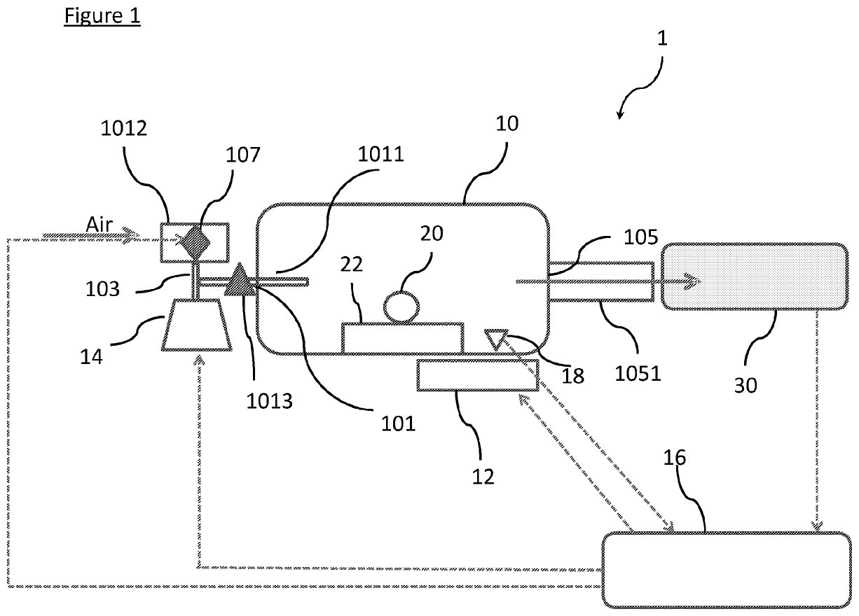

The apparatus 1 comprises a catalyst 20 selected from the group comprising Pt, PtCu, PtCo, PtNi, Pd, PtPd and/or PdCu. The catalyst 20 is supported by a support 22. The apparatus 1 further comprises a reaction chamber 10 for receiving the catalyst 20, wherein the reaction chamber 10 comprises an inlet 101 for air and reductant, and an outlet 105. The apparatus 1 further comprises a heater 12 configured to heat the catalyst to a temperature of from 20° C. to 100° C. The apparatus 1 may also include a temperature detector 18, but this is not essential. The apparatus 1 includes a source of reductant 14 which comprises a reductant, connected to the inlet 101 for delivering reductant into the reaction chamber 10. An inflow tube 1011 is connected to the inlet 101 for delivering atmospheric air and reductant into the reaction chamber 10. In a preferred embodiment, as illustrated in FIG. 1, air is channeled through air inlet pipe 1012. The source of reductant 14 and air inlet pipe 1012 are connected to each other by tubing 103. In an alternative embodiment, the apparatus 1 may comprise two inlets: one for air and the other for reductant. An outflow tube 1051 is connected to the outlet 105, wherein the outflow tube 1051 is configured to allow cleaned gas to exit the reaction chamber 10.

The apparatus 1 includes a heater 12 for heating the contents of the reaction chamber 10, including catalyst 20, to temperatures in the range of 20° C. to 100° C. Therefore, the apparatus facilitates reduction of NOx in a relatively low temperature range. The operating temperature range reaction chamber 10 is therefore at room temperature (i.e. 20° C.) or just above room temperature. The operating temperature is in any event substantially less than the effective temperature range of known SCR systems and is therefore safer. Thus, the apparatus described herein can safely improve the air quality inside an enclosed space, such as within a building, by reducing NOx in the air inside of the enclosed space. Alternatively, the apparatus can be used for reducing NOx in air outside of an enclosed space. For example, the apparatus can be deployed in road tunnels.

In a preferred embodiment, the heater 12 is configured to heat the catalyst 20 to temperatures of from 20° C. to 25° C. This temperature range is favourable when a Pt catalyst 20 supported on a titanium dioxide support 22 (Pt—TiO₂), is used in the apparatus, wherein the Pt has a concentration of 0.1 wt % with respect to the combined weight of the Pt catalyst and the titanium dioxide support. Operating in this temperature range using a 0.1 wt % Pt—TiO₂ catalyst, the conversion rate of NOx gases are approximately 33% N₂O and approximately 66% N₂.

In alternative embodiments, the catalyst 20 is bimetallic. In one embodiment, the catalyst 20 is PtCu and the support 22 is graphitic carbon nitride (gC₃N₄), i.e. PtCu-gC₃N₄. PtCu may be present in a concentration of from 0.1 wt % to 10 wt %, with respect to the combined weight of the catalyst 20 and the support 22. Relatively high NOx reduction is observed when 0.1 wt % PtCu-gC₃N₄ or 1 wt % PtCu-gC₃N₄ catalyst/support systems are used in the apparatus.

The catalyst 20 may be combined with any suitable support 22. Examples of catalyst 20 and support 22 combinations are: PtCu-gC₃N₄, Pt—TiO₂, Pd—TiO₂, and PtPd—TiO₂.

In alternative embodiments, the catalyst may be PtCo, PtNi or PdCu. The two metals in the bimetallic catalyst may be present in a molar ratio of 1:1 to 1:3. In some examples, PtCo, PtNi or PdCu are present in a weight percentage range of from 0.1 wt % to 10 wt %, with respect to the combined weight of the catalyst 20 and the support 22.

In an alternative embodiment, the heater is configured to heat the catalyst 20 to temperatures of from 65° C. to 75° C. In this temperature range, when the catalyst 20 is Pd and the support 22 is titanium dioxide (Pd—TiO₂), and wherein Pd has a concentration of 0.1 wt % with respect to the combined weight of the Pd catalyst and titanium dioxide support, the NOx gases are converted to 100% N₂, with no trace of N₂O.

The apparatus 1 can include a pump 107 for drawing air from outside the apparatus 1, such as from the environment in which the apparatus 1 is located, into the reaction chamber 10. In some embodiments, the pump 107 is inside an air inlet pipe 1012 connected to the air inlet 101. In some arrangements, the pump 107 can be located in an outlet pipe 1051 to pull air and reductant through the reaction chamber 10. A source of reductant 14 is connected to the reaction chamber 10 via tubing 103 and inflow tube 1011. Preferably, the connection between the source of reductant 14 and the tubing 103 is sealed such that reductant can be directed into the interior of the reaction chamber 10 without being lost to atmosphere.

In a preferred embodiment, the inlet 101 comprises a flow rate controller 1013 for increasing or decreasing the flow rate of reductant from a first flow rate. In use, a user may repeatedly and periodically increase the flow rate of reductant. For example, a first flow rate of reductant may be increased to a second flow rate for a period of 10 seconds by actuating the flow rate controller 1013. This creates a pulsing effect. By pulsing the reductant over the catalyst 20, the catalytic activity of catalyst 20 is effectively regenerated. Once the period of 10 seconds has elapsed, the flow rate controller 1013 is configured to decrease the flow rate of the reductant from the increased, second flow rate, back to the first flow rate. This pulsing of reductant may be repeated at intervals during the operation of the apparatus 1.

In a preferred embodiment, the reductant is hydrogen. The source of reductant 14 may comprise an electrolyser for converting water to hydrogen. Water can either be fed into the apparatus 1, or extracted from the atmosphere. Alternatively, the source of reductant 14 can be a canister or cylinder containing a mixture of hydrogen and an inert carrier gas. In an alternative embodiment, the apparatus 1 further comprises a source of a substance for providing the reductant (i.e. an indirect source of reductant). For example, the apparatus 1 may comprise a source of formaldehyde to provide hydrogen. The source of a substance for providing the reductant (e.g. hydrogen) can be considered to be the source of reductant 14. In one embodiment, hydrogen is present in a concentration of 0.05 v/v % to 4 v/v %. In an alternative embodiment, hydrogen is present in a concentration of 0.05 v/v % to 1 v/v %. Such concentrations of hydrogen do not pose a flammability risk.

A catalyst 20 is supported on a support 22 and contained inside the reaction chamber 10. The arrangement of the catalyst 20 and support 22 are not limited to that shown in FIG. 1. Any structural arrangements of catalyst 20 and support 22 which enable air and reductant to contact the catalyst 20 are favourable. In a preferred embodiment, the catalyst 20 is coated onto a support 20 in the form of a multichannel monolith, or beads packed in a tube.

The reaction chamber 10 is an enclosed space in which the reductant (e.g. hydrogen) and air drawn from outside the reaction chamber 10 can mix and are exposed to the catalyst 20. The catalyst 20 facilitates reaction of nitrogen monoxide (NO) with hydrogen to form nitrogen (N₂) and/or nitrous oxide (N₂O). Nitrogen (N₂) and nitrous oxide (N₂O) are inert, gaseous products. In use, cleaned air containing nitrogen (N₂) and nitrous oxide (N₂O) exit the reaction chamber 10 via the outlet 105 and are thus released into the atmosphere. Advantageously, the apparatus 1 does not suffer from a build up of nitrates or nitric acid on the surface of catalyst 20 because the reaction proceeds via a reductive pathway, rather than an oxidative pathway. Studies have shown that the catalyst 20 has a lifespan of at least two years. Thus, the apparatus 1 has a prolonged lifespan in comparison to known apparatus' using catalytic oxidation for minimising NOx.

The apparatus 1 can include a light source for illuminating the catalyst. This is particularly useful if the apparatus 1 is not exposed to natural light.

In some embodiments, the apparatus 1 includes a gas detector 30 in communication with the outlet 105. In the embodiment shown in FIG. 1, the gas detector 30 is connected to the outlet 105 of the reaction chamber 10 by an outlet pipe 1051. In some embodiments, the gas detector 30 can be connected directly to the outlet 1050. The gas detector 30 is configured to detect the concentration of nitrogen oxide (NO), and/or nitrogen dioxide (NO₂) and/or nitrous oxide (N₂O). The gas detector 30 may comprise a chemiluminescence detector, which detects a concentration of NO in a first stream of gas. Advantageously, a chemiluminescence detector has a wide NO detection range of 0.5 ppb to 20 ppm and is thus more sensitive to NO than conventional NO detectors. An alternative to a chemiluminescence detector is an electrochemical detector, which is advantageously of a small size and low cost. In a second, separate stream of gas, NO₂ will be converted to NO. The NO concentration in the second, separate stream is measured to provide a total NOx concentration. The NO₂ concentration can be determined by the difference between the total NOx concentration and the NO concentration. The gas detector 30 may additionally or alternatively comprise an infrared detector for detecting a concentration of N₂O. An infrared detector advantageously has an N₂O detection range of 20 ppb to 50 ppm.

In some embodiments, if the chemiluminescence detector 30 detects that the amount of NO and/or NO₂ exiting the reaction chamber 10 is above a first predefined threshold, it can transmit a control signal via controller 16 to the heater 12 to increase the temperature to increase the reaction rate in the reaction chamber 10 to result in cleaner air exiting the reaction chamber 10. Additionally or alternatively, a control signal can be sent from controller 16 to the source of reductant 14 in order to increase or decrease the concentration of reductant (e.g. hydrogen). Additionally or alternatively, a control signal can be sent to the pump 107 via controller 16 to reduce a flow of air into the reaction chamber 10, so that the volume of air through the reaction chamber 10 is reduced, thereby increasing the time in which reactions take place and ensuring that air exiting the reaction chamber 10 is cleaner. Similarly, if the detector 30 indicates that the amount of NO and/or NO₂ is below a second predefined threshold, a control signal can be sent to the heater via controller 16 to reduce the temperature to improve the energy efficiency of the reaction chamber, and/or a control signal can be sent to the pump 107 via controller 16 to increase the flow of air through the reaction chamber 10 to improve the amount of air cleaned in a given time.

The temperature detector 18 can feed information on the temperature of the apparatus 1 to the controller 16. Subsequently, the controller 16 can send a signal to the heater 12 to increase or decrease the temperature of the apparatus 1 and thus the temperature of the catalyst 20.

By heating the material inside the reaction chamber 10 to temperatures between 20° C. and 100° C., the reaction chamber 10, and an apparatus 1 including the reaction chamber 10, can be used in a variety of situations where use of conventional arrangements, which operate at higher temperatures, is not possible. For example, the apparatus 1 could be included inside buildings to provide cleaner air within the building. Multiple NOx reduction apparatus' 1 can be included in a single building depending on requirements. Each enclosed space (such as a room, corridor, stairwell etc.) of the building may have one or more NOx reduction apparatus' 1 to suit the needs in that enclosed space. For example, a garage may require multiple apparatus' 1, whereas an office above the garage may require one apparatus 1. Some enclosed spaces of the building may not require a NOx reduction apparatus.

In some examples, the apparatus 1 is included in a forced air central heating system. In other examples, the apparatus 1 is included in an air conditioning system. Alternatively, the apparatus 1 could be integrated into vehicles, such as aircraft (for example, in the cockpit or fuselage).

### Use of the Apparatus Inside an Enclosed Space

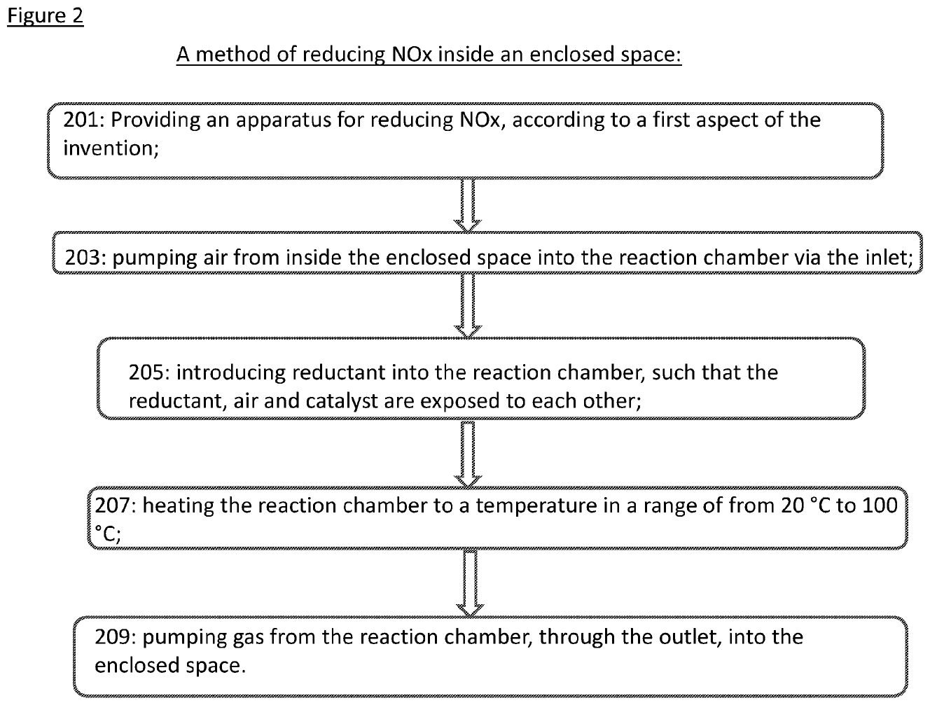

A method of reducing NOx inside an enclosed space, such as a building, will now be described. With reference to FIG. 2, a first step, 201, includes providing an apparatus 10 for reducing NOx, as described above. Once the apparatus is installed, air can be channelled into the reaction chamber 10 via the air inlet 101 in step 203. In the arrangement shown in FIG. 1, the air is channelled into the air inlet 101 via the air inlet pipe 1012 and inflow tube 1011. The air may be channelled into the reaction chamber 10 with the assistance of a pump 107. The pump 107 may be located in the air inlet pipe 1012, or in an air outlet pipe 1051. In some arrangements, the pump 107 is not needed in the apparatus 1 as the flow of air can be provided by a device to which the apparatus 1 is connected. For example, if the outlet 105 is connected to an air conditioning unit, means for drawing air through the air conditioning unit can also draw air through the reaction chamber 10.

At the same time as step 203, reductant can be introduced into the reaction chamber in step 205. The reductant, the air and the catalyst 20 are exposed to each other inside the reaction chamber. While the reductant, air and catalyst 20 are exposed to each other, the reaction chamber 10 is maintained at a temperature in a range of from 20° C. to 100° C. At step 209, gas (cleaned air) is channelled out of the reaction chamber 10. The gas exiting the reaction chamber 10 will have less NOx than the air entering through the air inlet 101. The gas exiting the reaction chamber 10, through the outlet 105, may be channelled directly into the enclosed space (e.g. a building), preferably via the outlet pipe 1051. Alternatively, the gas exiting the reaction chamber 10 can be channelled to a separate device. The separate device may adjust one or more properties of the air, such as the temperature and/or the humidity. For example, the device may be an air-conditioning unit, a de-humidifier or a forced air heating system.

The method described above may be performed to improve air quality inside of an enclosed space, for example in a room, stairwell or corridor of a building. The method is particularly useful where gas-fuelled appliances are installed, such as cookers, boilers and/or log burners. Similarly, it is beneficial to reduce the amount of NOx in buildings near a source of burning fossil fuels (such as, but not limited to, a busy road, a bus depot, a hanger at an air field, a cabin of a diesel train, etc). There is thus a need to be able to safely remove NOx from inside an enclosed space, for example, within a building.

In some embodiments, the source of reductant is hydrogen. The above method is advantageous due to NOx reduction occurring at relatively low temperatures compared with the prior art (in the range of from 20° C. to 100° C.). The use of such temperatures allows the method to be performed safely inside an enclosed space, e.g. within a building and does not prevent people from entering the enclosed space while the reaction proceeds.

### System for Monitoring NOx in a Plurality of Enclosed Spaces

A system for monitoring NOx in a plurality of enclosed spaces is described. The plurality of enclosed spaces may be a plurality of areas within one or more buildings. The system comprises a plurality of apparatus' 1 each including a gas detector 30 as described above, and a receiver configured to receive data regarding the NOx levels recorded by each of the plurality of apparatus. In the arrangement of FIG. 1, the gas detector 30 is shown as transmitting a signal to a controller 16. The controller 16 can then send a control signal to the pump 107 and/or the heater 12 of the apparatus 1. The gas detector 30 of each apparatus 1 can communicate with a central controller. In some arrangements, the central controller is provided in addition to a controller 16 associated with each apparatus 1. The central controller can send control signals to each apparatus 1 associated with the central controller to control the pump 107 and/or the heater 12. The central controller can analyse signals from each of the apparatus' 1 associated with the central controller, and can individually or collectively adjust the pumps 107 and/or heaters 12 of those apparatus' 1.

In an alternative embodiment, the apparatus' 1 may include a temperature detector 18. The temperature detector 18 in each of the respective apparatus can feed information on the temperature of the apparatus to the controller 16 of each of the apparatus. The temperature detector 18 can communication with the central controller, such that the central controller can analyse signals from each of the apparatus' 1 associated with the central controller, and can individually or collectively adjust the temperature of the heater 12 of those apparatus' 1.

### A Method of Preparing a Supported Catalyst for Reducing NOx

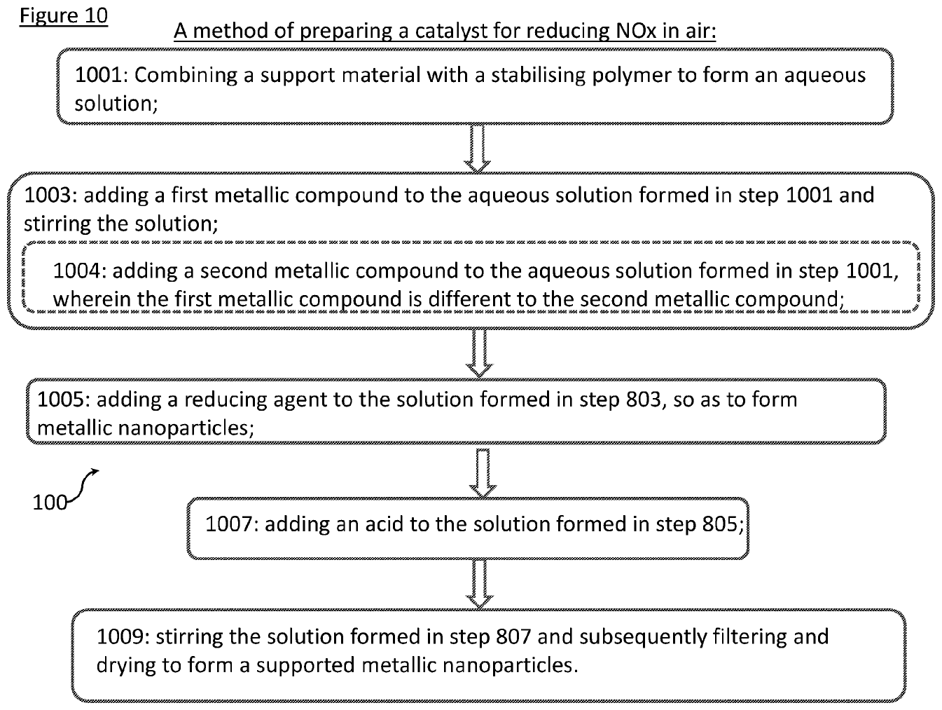

With reference to FIG. 10, a method (100) of preparing a supported catalyst for reducing NOx in air will now be described. The supported catalyst 20 is suitable for use in a reaction chamber 10 as described above. In step 1001, a support material is combined with a stabilising polymer in water to form an aqueous solution. The support material is preferably any material having a point zero charge of 5 to 7. For example, the support material may be graphitic carbon nitride (gC₃N₄), silica, alumina or titanium dioxide, or a combination thereof. The stabilising polymer (also known as a capping agent) can be polyvinyl alcohol.

At step 1003, a first metallic compound is added to the aqueous solution. In a preferred embodiment, a second metallic compound is added to the aqueous solution formed in step 1001, although this is not essential. The stabilising polymer binds to the metallic compound in order to prevent agglomeration of the resulting nanoparticles and limit particle size. The aqueous solution, with the first metallic compound added, can then be stirred to combine the first metallic compound into the aqueous solution. In a preferred embodiment where a second metallic compound is present, the first metallic compound is different to the second metallic compound.

It is preferred that the first metallic compound is (Pt(NH₃)₄(NO₃)₂). (Pt(NH₃)₄(NO₃)₂) has relatively low toxicity in comparison to many other platinum compounds. In an alternative embodiment, the first metallic compound comprises palladium. Palladium compounds PdCl₂ and K₂PdCl₄ have been found to be particularly advantageous. It is preferred that the second metallic compound comprises copper, such as a nitrate of copper, i.e. Cu(NO₃)₃·H₂O. In other arrangements, the first metallic compound is H₂PtCl₆·H₂PtCl₆ is widely available and commonly used in metallic (e.g. platinum) colloid preparation methods. In some arrangements, the second metallic compound comprises one of cobalt nitrate or nickel nitrate. In a preferred embodiment, the first metallic compound comprises platinum, the second metallic compound comprises copper, and the support material comprises graphitic carbon nitride (gC₃N₄). In a further preferred embodiment, the first metallic compound comprises platinum, the second metallic compound comprises palladium, and the support material comprises titanium dioxide.

Once the first (or first and second) metallic compounds have been combined into the aqueous solution, a reducing agent is added to the aqueous solution in step 1005. The reducing agent reduces the metal salts in solution. The reduced metals will form metallic nanoparticles. Any suitable, known reducing agent can be used. It is preferred, however, that sodium borohydride is used as the reducing agent. Sodium borohydride is a powerful and fast acting reducing agent. At step 807, an acid is added to the aqueous solution formed in step 1005. The acid decreases the pH of the solution to a range of pH 1 to 2, and provides an electronic charge to the support. Accordingly, the metallic nanoparticles are immobilised on the support material. For example, the acid may be one of sulphuric acid, or acetic acid. The aqueous solution formed in step 1007 is then stirred, filtered and dried in step 1009 to create the supported catalyst 20.

By combining the support material with a stabilising polymer to initially create the aqueous solution in step 1007, as set out above, a supported catalyst resulting from the present method provides higher conversion rates of NO to N₂O than a supported catalyst prepared via a conventional sol-immobilisation method, as discussed above.

In alternative embodiments, a single (first) metallic compound may be used in the method set out in FIG. 10 to prepare a monometallic catalyst. In these embodiments, the first metallic compound may comprise platinum or palladium. In preferred embodiments, the first metallic compound may be any of (Pt(NH₃)₄(NO₃)₂), PdCl₂, K₂PdCl₄ or H₂PtCl₆. In an alternative embodiment, the first metallic compound comprises palladium or platinum and the support material comprises titanium dioxide.

### Solution Preparation

In a preferred embodiment of the method, a support material is dispersed in deionised water, for example, by sonication, and stirred. The support material in this preferred embodiment graphitic carbon nitride (gC₃N₄). Other support materials can also be used, as mentioned above.

The dispersed graphitic carbon nitride (gC₃N₄) is combined with a stabilising polymer. It is preferred that the stabilising polymer is polyvinyl alcohol. Other stabilising polymers may be used, such as polyethylene glycol (PEG), or polyvinyl pyrrolidone (PVP).

Subsequently, a first metallic compound (or first and second metallic compounds) are added to the solution of dispersed support material (graphitic carbon nitride in the preferred embodiment) and stabilising polymer (polyvinyl alcohol in the preferred embodiment). When the supported catalyst is to be PtCu-gC₃N₄, the first metallic compound can be Pt(NH₃)₄(NO₃)₂ and in embodiments where a second metallic compound is present, the second metallic compound can be Cu(NO₃)₃·H₂O.

The solution is stirred until the first metallic compound, or the first and the second metallic compounds are thoroughly mixed. In a preferred embodiment, the solution is stirred for a period of 5 minutes (e.g. exactly 5 minutes, but at least between 4 minutes and 45 seconds and 5 minutes and 15 seconds). The solution can be stirred for longer as circumstances demand.

A reducing agent, such as sodium borohydride, is added to the solution drop-wise in order to prevent local regions of high concentration of reducing agent. In alternative embodiments, the reducing agent may be one of iron(II) sulfate, formic acid or ascorbic acid. The solution is stirred, for example, for 1 hour (e.g. exactly 1 hour, but at least between 45 minutes and 1 hour and 15 minutes), or until the Pt(NH₃)₄(NO₃)₂ and Cu(NO₃)₃·H₂O have reacted together to form bimetallic (PtCu) nanoparticles. In embodiments where only a first metallic compound is present, the solution is stirred until the metallic nanoparticles are formed. The solution can be stirred for longer as circumstances dictate. An acid, for example sulphuric acid, is subsequently added to the solution in order to decrease the pH of the solution to within a range of from pH1 to pH2 (wherein the end points of pH 1 and pH2 are included within this range), in order that the graphitic carbon nitride is electronically charged such that PtCu nanoparticles (or monometallic nanoparticles) will be immobilised on the surface of the graphitic carbon nitride. Once the acid has been added to solution, and the pH has been lowered, a solution wherein the bimetallic nanoparticles are immobilised on the support material will have formed. In the discussion above, the acid was indicated as sulphuric acid. Other acids, such as acetic acid, could be used instead of sulphuric acid.

### Filtration

Once formed, the solution is filtered. This can be done in any known manner. For example, a Buchner funnel with filter paper and a vacuum pump is prepared. With the pump running, the solution is poured onto the filter paper and the supernatant is allowed to pass through the filter paper, leaving a material on the filter paper. Different filtration techniques can be applied depending on the scale of production. For example, the material may be filtered through filter paper, relying only on gravity to separate the material from the supernatant (instead of a vacuum pump).

### Drying

The material is dried to form the catalyst. The material can be dried in any known manner. In some arrangements, the material is left to dry at a room temperature overnight, before being dried in a muffle furnace at 120° C. for four to twelve hours (wherein the end points of four and twelve hours are included in this range) In other arrangements, the material can be dried in a kiln or an oven.

### Grinding

Preferably, the particles of the catalyst are in the form of a powder. In order to obtain a powder, the dried supported catalyst material can be ground. Prior to use of the catalyst in the apparatus, the powder can be pressed and sieved to obtain a particle diameter in the range of 100 to 250 μm.

### Use of the Catalyst in an Apparatus for Reducing NOx in Air

A 1 wt % PtCu-gC₃N₄ supported catalyst was prepared. In order to synthesise 1 wt % PtCu-gC₃N₄, the first metallic compound used was (Pt(NH₃)₄(NO₃)₂). (Pt(NH₃)₄(NO₃)₂), and the second metallic compound used was Cu(NO₃)₃·H₂O. Polyvinyl alcohol was used as the stabilising polymer and sodium borohydride was used as a reducing agent.

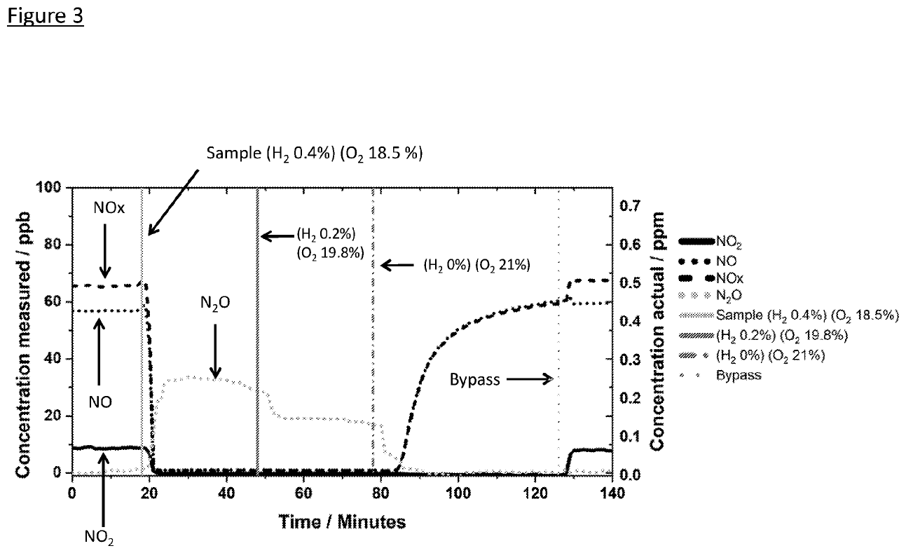

The supported catalyst was arranged in an apparatus according to the first aspect of the invention, and the reaction was conducted at room temperature (20° C.). FIG. 3 shows an activity plot for 1 wt % PtCu-gC₃N₄ in the presence of NO at a concentration of 0.5 ppm and a flow rate of 2 mL/min; and air at a flow rate of 95.5 mL/min. Hydrogen (reductant) is introduced into the apparatus (at a concentration of 4 v/v % and flow rate of 2.5 mL/min), along with air. The reaction gases are allowed to stabilise through a bypass before switching to the PtCu catalyst. At approximately 18 minutes, NOx is completely mitigated, and N₂O and N₂ are produced. As can be seen on the plot shown in FIG. 3, NOx concentration drops at approximately 18 minutes, while N₂O increases. The 1 wt % PtCu-gC₃N₄ supported catalyst thus achieves the effect of reducing NOx emissions.

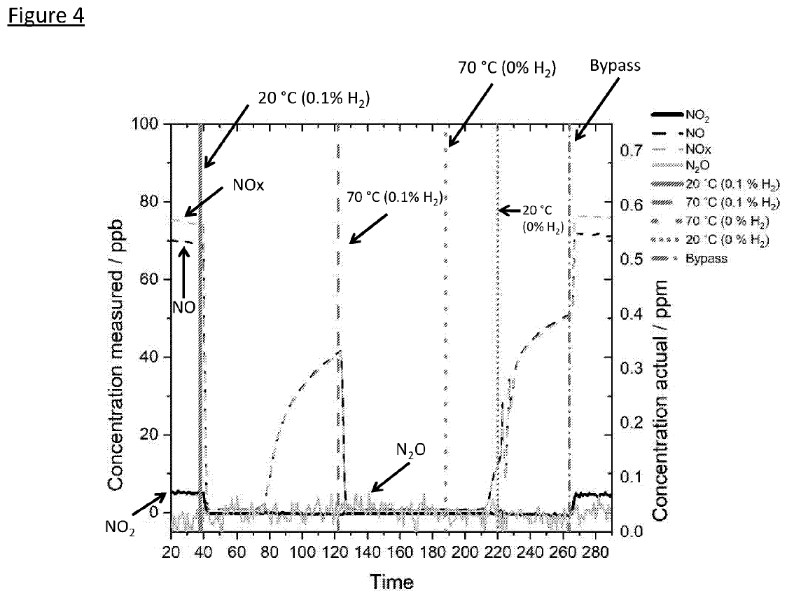

FIG. 4 shows an activity plot for a 0.1 wt % Pd—TiO₂ catalyst used in apparatus 1. The 0.1 wt % Pd—TiO₂ catalyst used in apparatus 1 is a monometallic catalyst which was prepared using a method falling within the scope of the present invention. The 0.1 wt % Pd—TiO₂ catalyst was exposed to NO at a concentration of 0.5 ppm and a flow rate of 2 mL/min; and hydrogen at a concentration of 0.1 v/v %, and flow rate of 2.5 mL/min. The flow rate was made up to a total flow rate of 100 mL/min in air. At 120 minutes, the temperature was increased to 70° C. and a reduction in NO was observed. N₂ was produced as a by-product, with no trace of N₂O.

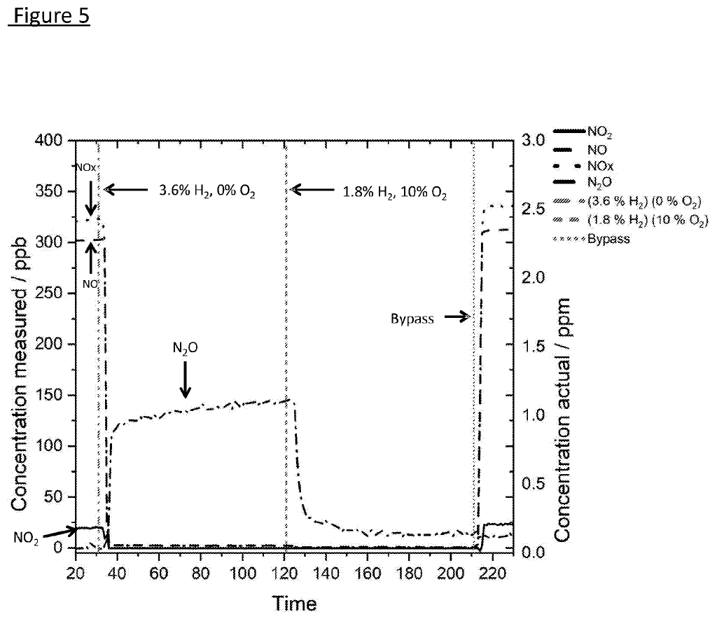

FIG. 5 shows a further activity plot for a 0.1 wt % Pd—TiO₂ catalyst used in apparatus 1. The catalyst was heated to 80° C. and was exposed to NO at a concentration of 0.5 ppm and hydrogen at a concentration of 3.6 v/v %. No air/oxygen was introduced at the beginning of the reaction. In the absence of oxygen, NOx is mitigated. The major product of NOx mitigation in the absence of oxygen is N₂O. With reference to the plot shown in FIG. 5, once the catalyst is exposed to oxygen, N₂O and N₂ are produced as reduction reaction by-products. Therefore, exposure of the catalyst to oxygen increases the selectivity towards N₂ as a by-product.

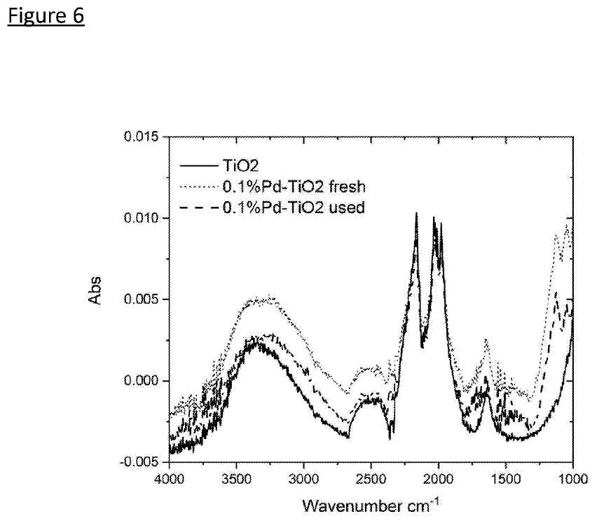

FIG. 6 shows ATR spectra of a 0.1 wt % Pd—TiO₂ catalyst before and after use in apparatus 1. The ‘fresh’ sample of 0.1 wt % Pd—TiO₂ is a spectrum taken before exposure of the catalyst to NOx, air and heat in apparatus 1. The ‘used’ sample of 0.1 wt % Pd—TiO₂ is after exposure of the catalyst to NOx, air and heat in apparatus 1. The ‘used’ sample was heated for four hours and exposed to 10 v/v % hydrogen and 2.5 ppm NO in air. With reference to the ATR spectrum for the ‘used’ sample of 0.1 wt % Pd—TiO₂ catalyst, there are no visible peaks which are characteristic of adsorbates. This advantageously confirms that there is no formation of nitrites, nitrosamines, ammonia, or ammonium nitrate during the catalytic reaction. Therefore, the surface of the catalyst does not suffer from poisoning by adsorbates. Accordingly, the catalyst directly converts NOx to nitrogen and/or N₂O.

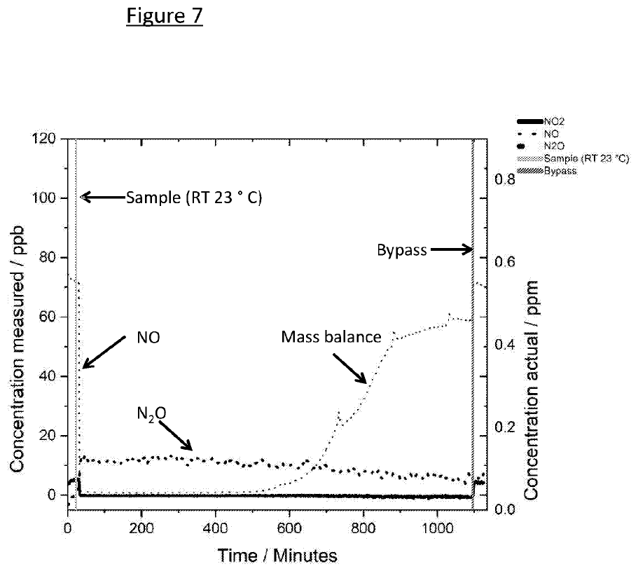

FIG. 7 shows an activity plot for a 0.1 wt % Pt—TiO₂ catalyst used in apparatus 1. The 0.1 wt % Pt—TiO₂ catalyst used to produce this plot was prepared using a method falling within the scope of the present invention, and was exposed to NO at a concentration of 0.5 ppm and a flow rate of 2 mL/min, with 98 mL/min of air and hydrogen. With respect to FIG. 7, the 0.1 wt % Pt—TiO₂ catalyst was exposed to hydrogen at a concentration of 0.05 v/v %, and flow rate of 1.3 mL/min; air (oxygen concentration of 20.5 v/v %); and NO at a concentration of 0.5 ppm, and a flow rate of 2 mL/min, in a total flow rate of 100 mL/min. The catalyst was heated to a temperature of 20° C. Under these conditions, the 0.1 wt % Pt—TiO₂ catalyst reduced the concentration of NOx for 8.5 hours. In order to regenerate the catalytic activity for another 8 hours, hydrogen is pulsed over the catalyst by use of the flow rate controller.

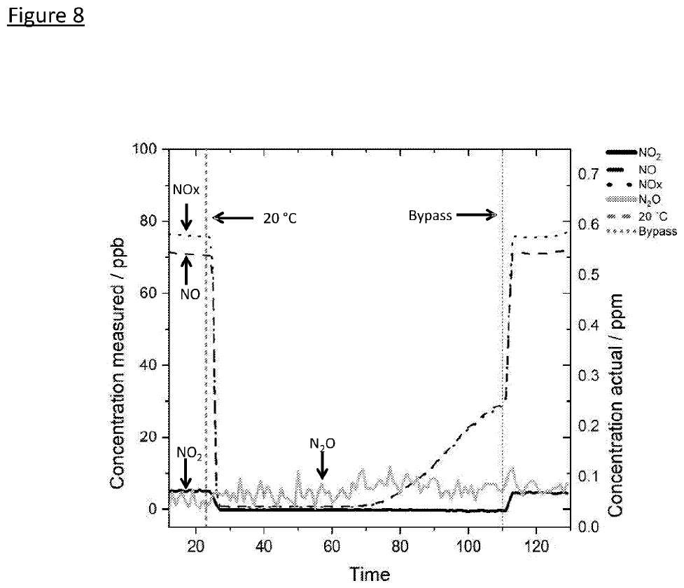

FIG. 8 shows an activity plot for a 0.05 wt % Pt 0.05 wt % Pd—TiO₂ catalyst used in the apparatus 1. The catalyst was exposed to NO at a concentration of 0.5 ppm and a flow rate of 2 mL/min; hydrogen at a concentration of 0.1 v/v %; and oxygen at a concentration of 20.5 v/v %. As can be seen from FIG. 8, the catalyst which was exposed to a temperature of 20° C. is able to reduce the concentration of NOx.

### Comparative Experiments

Experiments were performed to compare the catalytic behaviour of a 1 wt % PtCu-gC₃N₄ catalyst prepared via a conventional sol-immobilisation preparation method (i.e. Method 1) and a 1 wt % PtCu-gC₃N₄ supported catalyst prepared via a method falling within the scope of the present invention (i.e. Method 2).

The catalysts were used in the apparatus 1 according to the present invention. The 1 wt % PtCu-gC₃N₄ catalyst reduces NOx concentration in air via a reductive pathway. The catalyst was exposed to NO at a concentration of 5000 ppm. The catalyst reduces NO to form N₂O and nitrogen in the presence of a reducing agent (hydrogen, in this instance). The NO to N₂O conversion rates and particle diameters of PtCu for 1 wt % PtCu-gC₃N₄ prepared via Methods 1 and 2 are set out in Table 1:

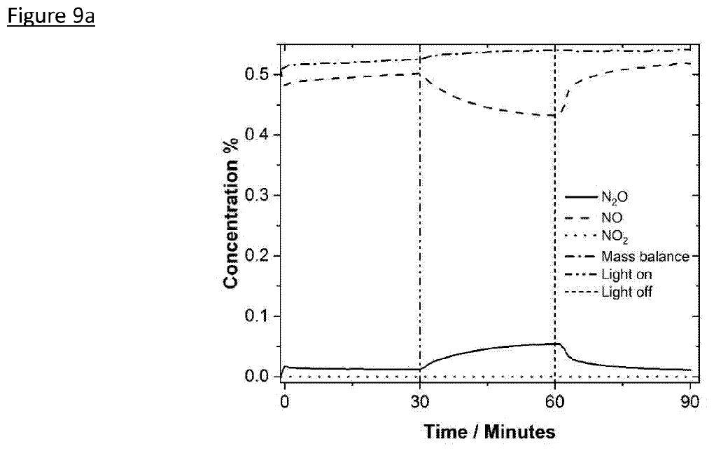

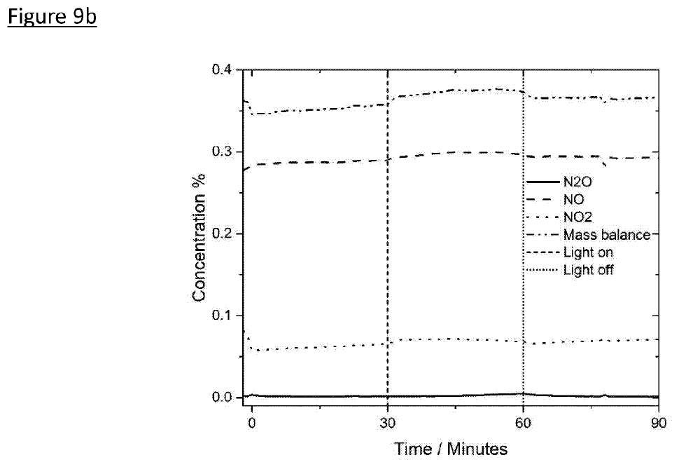

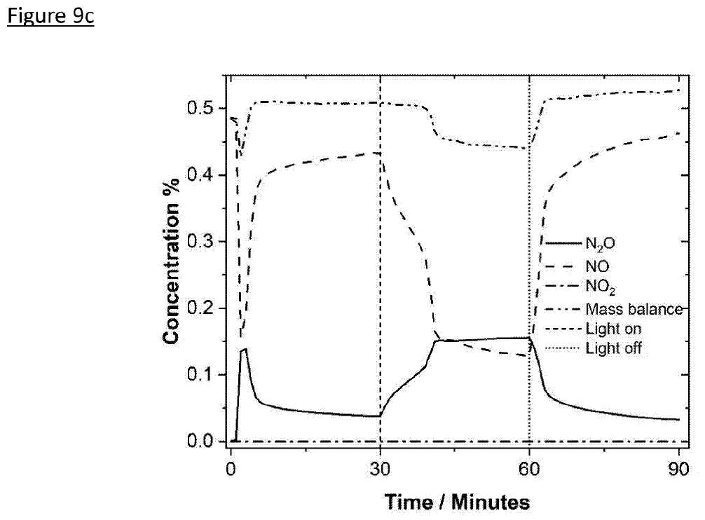

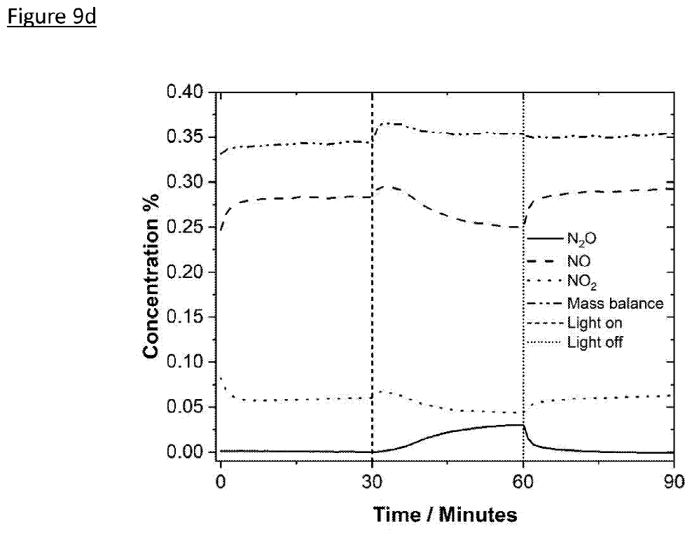

TABLE 1

| | | Conversion | Conversion of | |
|---|---|---|---|---|
| | | of NO to N₂O | NO to N₂O in | |
| | Corre- | in the | the presence of | Particle |
| Catalyst | sponding | presence of | oxygen and | (PtCu) |
| Material | FIGS. | heat (50° C.) | heat (50° C.) | diameter |
| 1 wt % PtCu- | FIGS. 9a | 20% | 0 | 3 to 4 nm |
| gC₃N₄ | and 9b | | | |
| obtained via | | | | |
| Method 1 | | | | |
| 1wt % PtCu- | FIGS. 9c | 50% | 12% | 2 to 3 nm |
| gC₃N₄ | and 9d | | | |
| obtained via | | | | |
| Method 2 | | | | |

It can be seen from the results in Table 1 (and in FIGS. 9a to 9d, as discussed below) that 1 wt % PtCu-gC₃N₄ prepared via Method 2 achieves higher conversion rates of NO to N₂O in the presence of heat; and in the presence of heat and oxygen, compared with 1 wt % PtCu-gC₃N₄ prepared via Method 1 under the same conditions. Accordingly, 1 wt % PtCu-gC₃N₄ prepared via Method 2 provides an improved NOx reducing effect than 1 wt % PtCu-gC₃N₄ prepared via conventional Method 1.

As set out in Table 1, conventional Method 1 produces larger PtCu particles (3 to 4 nm in diameter), whereas Method 2 produces smaller PtCu particles (2 to 3 nm in diameter). The higher conversion rates of NO to N₂O by 1 wt % PtCu-gC₃N₄ obtained via Method 2 may therefore be attributed to the increased surface area to volume ratio of the PtCu particles (compared with the PtCu particles obtained via Method 1) and reduced alloying between platinum and copper.

FIGS. 9a and 9b show activity plots for 1 wt % PtCu-gC₃N₄ obtained via conventional preparation Method 1. In order to simulate atmospheric conditions, the catalyst was exposed to a flow of NO. Referring to the plot shown in FIG. 9a, 1 wt % PtCu-gC₃N₄ was exposed to 1% v/v NO in helium at a flow rate of 10 ml/min, and 4% v/v hydrogen (reducing agent) in helium at a flow rate of 10 ml/min, in the presence of heat (50° C.). N₂O was observed as a by-product of the catalysed reaction between hydrogen and NO. The conversion of NO to N₂O was 20% for 1 wt % PtCu-gC₃N₄ prepared via Method 1.

Referring to FIG. 9b, 1 wt % PtCu-gC₃N₄ was exposed to 1% v/v NO in helium at a flow rate of 7 ml/min, 4% v/v hydrogen (reducing agent) in helium at a flow rate of 7 ml/min, and 10% v/v oxygen in helium at a flow rate of 7 ml/min. The catalyst was also exposed to heat (50° C.). N₂O was not observed to be produced. Thus, in the presence of oxygen, 1 wt % PtCu-gC₃N₄ prepared via Method 1 did not display any NOx reducing activity. In other words, NO was not converted to N₂O.

FIGS. 9c and 9d show activity plots for 1 wt % PtCu-gC₃N₄ obtained via Method 2 (i.e. the method of the present invention). FIG. 9c shows an activity plot of 1 wt % PtCu-gC₃N₄ exposed to 1% v/v NO in helium at a flow rate of 10 ml/min, and 4% v/v hydrogen (reducing agent) in helium at a flow rate of 10 ml/min. It was observed that the conversion of NO to N₂O in the presence of heat (50° C.) was 50%.

FIG. 9d shows an activity plot of 1 wt % PtCu-gC₃N₄ exposed to 1% v/v NO in helium at a flow rate of 7 ml/min, 4% v/v hydrogen (reducing agent) in helium at a flow rate of 7 ml/min, and 10% v/v oxygen in helium at a flow rate of 7 ml/min. When exposed to heat (50° C.), it was observed that the conversion of NO to N₂O was 12%.

It can therefore be deduced that 1 wt % PtCu-gC₃N₄ prepared via Method 2 provides a more effective NOx reducing catalyst than 1 wt % PtCu-gC₃N₄ prepared via Method 1.

Many other variants and embodiments will be apparent to the skilled reader, all of which are intended to fall within the scope of the invention whether or not covered by the claims as filed. Protection is sought for any and all novel subject matter and combinations thereof disclosed herein.

1. An apparatus for reducing NOx in air, wherein the apparatus comprises:
a catalyst, wherein the catalyst comprises one or more of Pt, PtCu, PtCo, PtNi, Pd, PtPd and PdCu;
a reaction chamber for receiving the catalyst, wherein the reaction chamber comprises an inlet for air and reductant, and an outlet;
a heater configured to heat the catalyst to temperatures of from 20° C. to 100° C.; and
a source of reductant, wherein the source of reductant is connected to the inlet.

2. The apparatus according to claim 1, wherein the reductant is hydrogen.

3. The apparatus according to claim 2, further comprising a source of a substance for providing the reductant.

4. The apparatus according to claim 3 wherein the heater is configured to heat the catalyst to temperatures of from 20° C. to 25° C.

5. The apparatus according to claim 1, wherein the source of reductant comprises an electrolyser for producing the reductant.

6. The apparatus according to claim 1, wherein when the reductant is hydrogen, the hydrogen is present in a concentration of 0.05 v/v % to 4 v/v %.

7. The apparatus according to claim 6, wherein hydrogen is present in a concentration of 1 v/v % to 4 v/v %.

8. The apparatus according to claim 1, further comprising a flow rate controller for increasing or decreasing the flow rate of the reductant.

9. The apparatus according to claim 8, wherein the flow rate controller is configured to increase the flow rate of the reductant for 5 to 15 seconds.

10. The apparatus according to claim 1, wherein the catalyst is supported on a support.

11. The apparatus according to claim 10, wherein the catalyst is present in an amount of from 0.1 wt % to 10 wt % with respect to the combined weight of the catalyst and the support.

12. The apparatus according to claim 11, wherein the catalyst is PtCu, the support is gC3N4, and PtCu is present in an amount of 0.1 wt % to 10 wt % with respect to the combined weight of PtCu and gC3N4.

13. The apparatus according to claim 1, further comprising at least one gas detector in communication with the outlet, wherein the at least one gas detector is configured to detect one or more of nitrogen monoxide (NO and nitrous oxide (N2O) in the gas which exits the reaction chamber.

14. The apparatus according to any claim 13, wherein the at least one gas detector comprises a chemiluminescence detector for detecting one or more of nitric oxide (NO) and nitrogen dioxide (NO2).

15. The apparatus according to claim 13, wherein the at least one gas detector comprises an infrared detector for detecting nitrous oxide (N2O).

16. A system for monitoring the concentration of NOx in air in a plurality of enclosed spaces comprising:
a plurality of the apparatus as defined in claim 1, wherein each of the plurality of apparatus' comprises at least one gas detector in communication with the outlet, wherein the at least one gas detector is configured to detect one or more of nitrogen monoxide (NO) and nitrous oxide (N2O) in the gas which exits the reaction chamber; and wherein each of the plurality of the apparatus are positioned in each of the plurality of enclosed spaces.

17. A method of reducing NOx inside an enclosed space, comprising:
providing an apparatus for reducing NOx according to claim 1;
pumping air from inside the enclosed space into the reaction chamber via the inlet;
introducing reductant into the reaction chamber, such that the reductant, air and catalyst are exposed to each other;
heating the reaction chamber to a temperature in a range of from 20° C. to 100° C.; and
pumping gas from the reaction chamber, through the outlet, into the enclosed space.

18-24. (canceled)
